(19) United States
(12) Patent Application Publication
(10) Pub. No.: US 2023/0027331 A1
(43) Pub. Date: Jan. 26, 2023

(54) METHOD FOR MANUFACTURING A COMPONENT, COMPONENT, AND PRODUCTION FACILITY FOR MANUFACTURING THE COMPONENT

(71) Applicant: EDAG Engineering GmbH, Wiesbaden (DE)

(72) Inventor: Franz Lorey, Huenfeld (DE)

(21) Appl. No.: 17/785,570

(22) PCT Filed: Nov. 9, 2020
(86) PCT No.: PCT/EP2020/081410

§ 371 Date: Jun. 15, 2022

(30) Foreign Application Priority Data
Dec. 18, 2019 (DE) 10 2019 220 039.7

(51) Int. Cl. B21F 27/10

(52) U.S. Cl. CPC B21F 27/10

(57) ABSTRACT

Method for manufacturing a component from polyhedra having polyhedron edges which are formed from a semi-finished product, component and production facility. The method has the steps of: subdividing the component to be produced into a net of polyhedra, consisting of polyhedron edges, which are interconnected at the polyhedron node points thereof to form the net; providing a semi-finished product provision device, which provides the semi-finished product; providing a supply guide device for supplying the semi-finished product from the semi-finished product provision device and positioning the semi-finished product; providing a cutting and welding device or a welding device for welding and a cutting device for cutting to size the semi-finished product; supplying the semi-finished product by way of the supply device; constructing the net of polyhedra by positioning the supplied semi-finished product in the position of the polyhedron edge to be formed at the associated polyhedron node point of the net of polyhedra in each case, and fixing the semi-finished product at the polyhedron node point by welding.

### FIELD OF THE INVENTION

The present invention relates to a method for producing a component, to the component and to a production facility for manufacturing the component.

### TECHNICAL BACKGROUND

Laser sintering is generally known as a generative layered construction method in which the workpiece is constructed layer by layer. Because of the high mechanical complexity and in particular the process times, which are dependent on the volume generated, laser sintering is used in particular for making prototypes and small unit numbers of complicated parts.

### SUMMARY OF THE INVENTION

Against this background, the object of the invention is now to provide an improved method as well as an improved component and a production facility for manufacturing the component.

According to the invention, this object is achieved by a method having the features of claim 1 as well as a component having the features of claim 8 and a production facility having the features of claim 9.

Accordingly, a method is provided for manufacturing, in particular in an automated and preferably fully automated manner, a component from polyhedra having polyhedron edges, which are formed from a semi-finished product, the method having the steps of:
subdividing the component to be produced into a net of polyhedra, consisting of polyhedron edges, which are interconnected at the polyhedron node points thereof to form the net,
providing a semi-finished product provision device, which provides the semi-finished product,
providing a supply device for supplying the semi-finished product from the semi-finished product provision device and positioning the semi-finished product,
providing a cutting and welding device or a welding device for welding and a cutting device for cutting to size the semi-finished product,
supplying the semi-finished product by way of the supply device,
constructing the net of polyhedra by positioning the supplied semi-finished product in the position of the polyhedron edge to be formed at the associated polyhedron node point of the net of polyhedra in each case, and fixing the semi-finished product at the polyhedron node point by welding.

The method has the advantage that it allows very simple, cost-effective manufacture of a component by using a semi-finished product. This is very simple to weld to the net structure of the component. At the same time, as a result of the net structure of polyhedra, a stable and lightweight construction can be achieved and the use of the semi-finished product can be optimised.

Further, a component is provided which consists of a net of polyhedra having polyhedron edges, the polyhedron edges being formed from a semi-finished product and interconnected by welding.

The component has the advantage that because of its net structure of polyhedra it is stable and simultaneously cost-effective as a result of the use of the semi-finished product.

Further, a production facility is provided for manufacturing a component from polyhedra having polyhedron edges, which are formed from a semi-finished product and interconnected by welding, the production facility having:
a semi-finished product provision device for providing the semi-finished product,
a supply guide device for supplying the semi-finished product from the semi-finished product provision device and positioning the semi-finished product,
a cutting and welding device, or a welding device for welding the semi-finished product and a cutting device for cutting to size the semi-finished product.

The production facility has the advantage that it allows the manufacture of a component from a net of polyhedra by processing a semi-finished product, without generating large amounts of excess material, as for example in the case of laser sintering, in which unsolidified material has to be removed subsequently.

Advantageous embodiments and developments will be apparent from the further dependent claims and from the description with reference to the drawings.

In one embodiment of the invention, the semi-finished product provision device provides the semi-finished product with the predetermined length or lengths of the polyhedron edges of the polyhedra of the net. The supply guide device supplies the semi-finished product to the semi-finished product provision device, for example as a function of or in accordance with the length of the polyhedron edge to be formed in each case, and positions the semi-finished product.

In one embodiment of the invention, the semi-finished product is cut to size to the predetermined length of the polyhedron edge to be formed. In this context, the semi-finished product is cut to size for example before and/or after the semi-finished product is positioned in the position of the polyhedron edge to be formed at the associated polyhedron node point of the net of polyhedra in each case, and/or the semi-finished product is cut to size for example before and/or after the semi-finished product is fixed to the polyhedron node point by welding.

In a further embodiment of the invention, the polyhedra are manufactured from an identical semi-finished product, or at least some of the polyhedra of the component are manufactured from at least two different semi-finished products. In this context, the two different semi-finished products differ from one another for example at least in material, dimensioning and/or cross section.

In another embodiment of the invention, a connecting element provision device is provided to provide a connecting element. In this context, the connecting element is supplied by means of the supply device. Further, the supplied connecting element is positioned as a polyhedron node point in each case for fixing the polyhedron edges associated with the polyhedron node point to the connecting element by welding to form the net of polyhedra.

In one embodiment of the invention, the polyhedron edges of the polyhedra of the net of polyhedra are directly interconnected and welded together at at least some or all polyhedron node points, or interconnected via a connecting element as a polyhedron node point in each case and welded to the connecting element.

In one embodiment of the invention, the same connecting element is provided for at least some or all polyhedron node points of the net of polyhedra, or at least two different connecting elements are provided. In this context, the at least two different connecting elements differ from one another for example at least in material, dimensioning and/or cross section.

In a further embodiment of the invention, the semi-finished product is a rod-shaped, weldable material. The rod-shaped, weldable material is for example a rod-shaped, weldable metal or a rod-shaped, weldable metal alloy. Likewise, the connecting element consists of a weldable material, for example a weldable metal or weldable metal alloy. In particular, the connecting element consists of the same material as the semi-finished product.

In one embodiment of the invention, the semi-finished product provision device has at least one roller device having at least one roller, at least one storage plate and/or at least one storage container.

In one embodiment of the invention, the production facility has a connecting element provision device. The connecting element provision device has for example at least one storage plate and/or at least one storage container.

In a further embodiment of the invention, the production facility has at least one robot device, the robot device having at least one cutting and welding robot arm, at least one welding robot arm, at least one cutting robot arm and/or at least one supply robot arm for supplying the semi-finished product and/or supplying a connecting element.

In one embodiment of the invention, the production facility has at least one construction platform. In this context, the at least one construction platform is a stationary or mobile/movable construction platform. The mobile/movable construction platform is formed in such a way that it allows movement in at least one, two or three degrees of freedom. The at least one construction platform may optionally additionally have at least one mounting device for receiving and holding a supplied semi-finished product.

The above embodiments and developments may be combined with one another as desired, within reason. Further possible embodiments, developments and implementations of the invention also include combinations not explicitly mentioned of features of the invention which are described above or in the following with reference to the drawings. In particular, a person skilled in the art will also add individual aspects to each base form of the present invention as improvements or supplements.

### CONTENTS OF THE DRAWINGS

In the following, the present invention is described in greater detail by way of the embodiments set out in the schematic drawings, in which:

FIG. 1 is a schematic view of a production facility for manufacturing a component according to an embodiment of the invention;

FIG. 2 is a schematic cross-sectional view of an embodiment of a semi-finished product;

FIG. 3 is a schematic cross-sectional view of a further embodiment of a semi-finished product;

FIG. 4 is a schematic cross-sectional view of another embodiment of a semi-finished product;

FIG. 5 is a schematic cross-sectional view of a further embodiment of a semi-finished product;

FIG. 6 is a schematic cross-sectional view of one more further embodiment of a semi-finished product;

FIG. 7 is a schematic perspective view of an embodiment of a connecting element and semi-finished products fixed thereto;

FIG. 8 is a schematic perspective view of a further embodiment of a connecting element and semi-finished products fixed thereto;

FIG. 9A is a perspective view of a net of the polyhedra which have been derived from a solid body in a first step to create a component according to the invention in the form for example of a lorry cab or lorry cab frame.

FIG. 9B is a perspective view of an embodiment of a component according to the invention in the form of a cab frame based on the net of polyhedra according to FIG. 9A, the number of polyhedra of the cab frame according to FIG. 9A having been reduced further in a second step;

FIG. 10 is an enlarged detail of the cab frame according to FIG. 9B;

FIG. 11 is a front view of the cab frame according to FIG. 9B;

FIG. 12 is a side view of the cab frame according to FIG. 9B;

FIG. 13 is another side view of the cab frame according to FIG. 9B;

FIG. 14 is a perspective view of two semi-finished products to be welded together along with the semi-finished product ends thereof;

FIG. 15 is a perspective view of the semi-finished products according to FIG. 15 welded together;

FIG. 16 is a perspective view of three other semi-finished products to be welded together along with the semi-finished product ends thereof;

FIG. 17 is a perspective view of the semi-finished products according to FIG. 16 welded together;

FIG. 18 is a perspective view of three further semi-finished products welded at the semi-finished product ends thereof;

FIG. 19 shows a semi-finished product having a pyramid-shaped semi-finished product end according to FIGS. 14 and 15, the angle of inclination being the same;

FIG. 20 shows a semi-finished product having a pyramid-shaped semi-finished product end according to FIGS. 14 and 15, the angle of inclination being different;

FIG. 21 is a front view of a tube and its decomposition into a net of polyhedra; and

FIG. 22 shows an annular portion from which the tube in FIG. 21 is constructed.

The accompanying drawings are intended to convey a further understanding of the embodiments of the invention. They illustrate embodiments, and serve, in conjunction with the description, to explain principles and concepts of the invention. Other embodiments and many of the mentioned advantages will be apparent from the drawings. The elements of the drawings are not necessarily shown to scale with one another.

In the drawings, unless stated otherwise, like, functionally equivalent and equivalently operating elements, features and components are provided with like reference numerals in each case.

### DESCRIPTION OF EMBODIMENTS

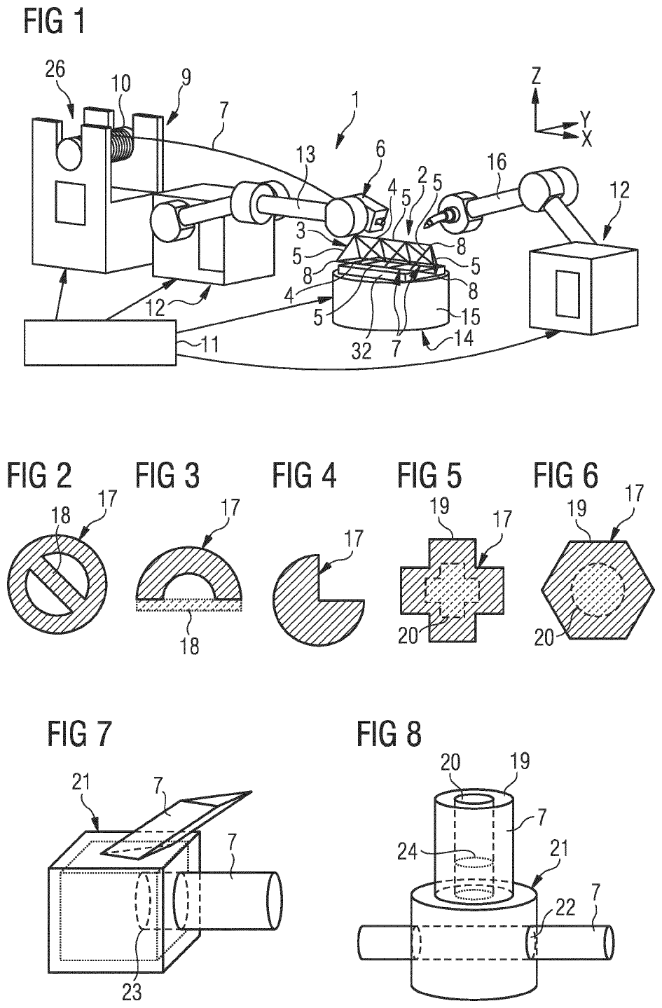

FIG. 1 shows an example of a production facility 1, in particular an automated and preferably fully automated production facility, for manufacturing a component 2 according to the invention. The production facility 1 is shown highly simplified, purely schematically, and not to scale. Further, FIGS. 2 to 6 show various examples of cross-sectional shapes of semi-finished products from which the component according to the invention can be manufactured.

As an embodiment of a component 2 according to the invention, FIG. 1 shows by way of example a carrier 3. The component 2 according to the invention is understood as and is formed from a complex polyhedral structure and in particular a complex triangle structure.

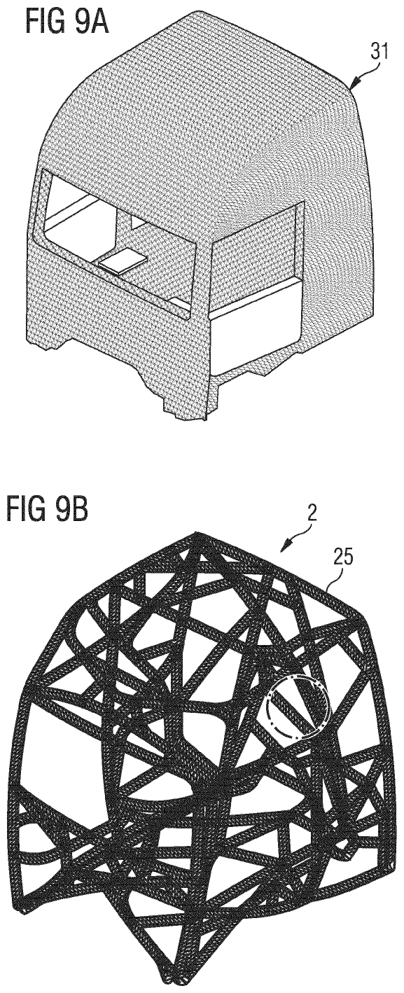

The component to be manufactured is subdivided into a net of polyhedra. The polyhedra are formed from their polyhedron edges, and form a net of framework rods. The polyhedron edges of the polyhedra are interconnected at polyhedron node points to form the polyhedral net. Two examples of components subdivided into a net of polyhedra in this manner are shown in FIG. 1 and in the following FIGS. 9A, 9B and 10 to 13. The net of polyhedra may also consist of similar, equal-sized polyhedra, like the carriers in FIG. 1, or of different polyhedra and similar but different-sized polyhedra. In the net of polyhedra, different polyhedra and different sizes of polyhedra may be combined with one another as desired, depending on the function and purpose of use. This applies to all embodiments of the invention. To subdivide the component into a net of polyhedra, for example the finite element method (FEM) may be used. However, the invention is not limited to this.

The volume or shape or frame of the component 2 to be manufactured can thus be formed from a net of polyhedra 4 on the basis of a 3D model. As polyhedra 4, according to the invention any type of polyhedron may be provided, depending on the function and purpose of use. In particular, as polyhedra, preferably triangular pyramids, in particular regular triangular pyramids, having at least one triangular face, such as a tetrahedron or triangular pyramid, pentahedron or square pyramid, heptahedron, enneahedron, decahedron, hendecahedron, tridecahedron, tetradecahedron, pentadecahedron, hexadecahedron, heptadecahedron, octadecahedron, enneadecahedron, icosahedron, icosidihedron, triacontahedron, hexacontahedron etc. may be provided.

An example of the formation of a component from a net of polyhedra is also shown in the following FIGS. 21 and 22. Therein, by way of example, a tube is formed from a net of polyhedra, as is shown in FIG. 21. The tube is formed from annular portions or ring segments, as is shown in FIG. 22.

Analogously to conventional FEM programs, the size of the polyhedra 4 and in particular the size of the triangular pyramids may be specified or set as a function of the purpose of manufacture and the associated precision. The polyhedron edges 5 of these polyhedra 4, in particular triangular pyramids, are, as noted above, treated as framework rods and welded together in a suitable position or situation with respect to the desired polyhedron 4 and ultimately the desired component 2 from a network of at least two polyhedra 4. An example of manufacturing a component 2 of this type, in this case a carrier 3 constructed from polyhedra 4 in the form of triangular pyramids, is shown in FIG. 1. A further example of a component according to the invention is shown in the following FIGS. 9 to 13.

As noted above, FIG. 1 shows an embodiment of a production facility 1 for manufacturing the components according to the invention. The production facility 1 in the example shown has a semi-finished product provision device 26, which provides the semi-finished product 7, and a supply device 6, which supplies the semi-finished product 7 to the semi-finished product provision device 26, in particular a processing station 14. Subsequently, by means of the supplied semi-finished product 7, the polyhedron edges 5 of the polyhedra 4 of the component 2 to be manufactured are formed. As a semi-finished product 7, for example at least one weldable, rod-shaped material is provided by the semi-finished product provision device 26 and supplied by the supply device 6. The weldable, rod-shaped semi-finished product 7 may be manufactured for example from a weldable metal or weldable metal alloy. The following table gives examples of different welding methods and examples of the materials or substances which can be welded by these welding methods to manufacture a component 2 according to the invention:

| Welding method | Material or substance |
|---|---|
| Gas fusion welding | Unalloyed steels |
| Manual electric welding | All steels |
| Resistance spot welding | All metals |
| WIG welding | All metals |
| MIG welding | Alloyed steels, |
| | non-ferrous metals |
| MAG welding | All steels |
| Laser welding | All steels, light metals |
| Plasma welding | All steels, light metals |

The weldable, rod-shaped material is formed as a solid or hollow profile, in particular a tube profile, and is processed as a semi-finished product 7. The rod-shaped material in the form of a solid or hollow profile has for example a round solid or hollow profile cross section and/or an angular solid or hollow profile cross section, for example a circular solid or hollow profile cross section, an oval solid or hollow profile cross section, a polygonal solid or hollow profile cross section, for example an at least three-cornered, four-cornered, five-cornered or six-cornered solid or hollow profile cross section etc., or a for example cross-shaped solid or hollow profile cross section etc., depending on the function and purpose of use. In the case of a hollow profile, this may have a round and/or polygonal hollow profile cross section, as is shown by way of example in the following FIG. 2, FIG. 5 and FIG. 6 by way of example. The external contour and/or internal contour of the hollow profile have the same or a different round and/or angular contour for forming the round and/or angular hollow profile cross section, as is also shown by way of example in the following FIGS. 2, 5 and 6. As semi-finished products 7, in particular cylindrical solid profiles and cylindrical hollow profiles having a circular external contour and a circular internal contour may be used. The weldable, rod-shaped material in the form of a solid or hollow profile may in principle have any cross section, depending on the function and purpose of use. This applies to all embodiments of the invention.

The weldable, rod-shaped material is processed as the semi-finished product 7, and in one embodiment the semi-finished products 7 are welded together directly. The semi-finished products 7 are welded together at their respective polyhedron node points 8 as polyhedron edges of the associated polyhedron of the net of polyhedra.

A polyhedron node point is the point at which edges of a polyhedron meet. Moreover, a polyhedron node point is also a point at which the edges of two adjacent polyhedra meet.

Aside from the polyhedron node points, further or other welding points may also be provided if the component is manufactured from polyhedra.

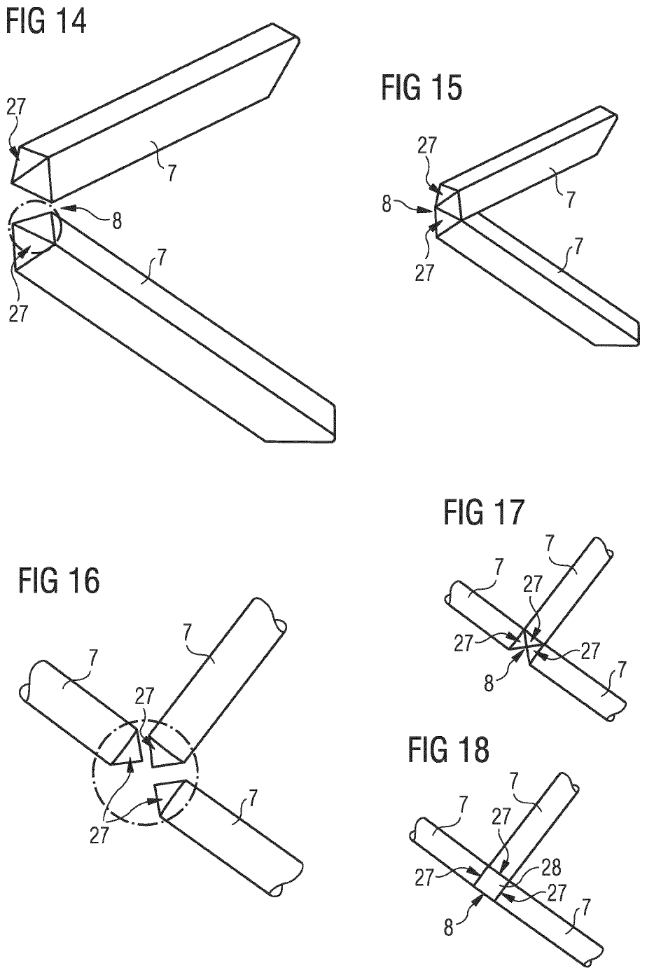

The following FIG. 14-18 show various examples of semi-finished product ends 27 of semi-finished products 7, which are welded together for example at an associated polyhedron node point 8.

In a further embodiment, however, a connecting element may optionally also additionally be provided between at least two semi-finished products 7 to be welded together, as is shown in a highly simplified and purely schematic manner in the following FIGS. 7 and 8. This is advantageous in particular if the polyhedron edges 5 of the component 2 are formed from solid and/or hollow profiles which have a relatively large cross section or for example cannot suitably be welded together directly, for example because of semi-finished products 7 having different cross sections and/or materials etc. By way of example, in this case, at the connecting point of two semi-finished products 7, in particular a polyhedron node point or another welding point, an additional connecting element of this type may be provided between the two semi-finished products 7, and instead of the semi-finished products 7 being welded together directly the semi-finished products may instead be welded to the connecting element and thus interconnected. The associated connecting element may in particular form a polyhedron node point to which the semi-finished products 7 forming the polyhedron edges 5 of the associated polyhedron are welded. In this way, the semi-finished products 7, as polyhedron edges 5 of an associated polyhedron 4, may be rigidly interconnected by the connecting element by welding to the shared connecting element.

The connecting element may for example be a round, in particular spherical, and/or angular shape and be for example a sphere, a cylinder or a polygon. The connecting element may be a solid or hollow profile. Further, the connecting element may, for receiving the end of a semi-finished product 7, have a depression, as in the following FIG. 7, or in in the case of a hollow profile an opening, as in the following FIG. 7, for example a solid sphere or a solid cube, as a connecting element having for example two depressions for receiving the associated end of two semi-finished products, or a hollow sphere or a hollow cube having two openings for inserting the ends of two semi-finished products etc. The semi-finished products are subsequently welded to the connecting element and thus interconnected. Likewise, the connecting element may also by way of example have a projection for plugging an end of an associated semi-finished product onto the projection, as is shown in the following FIG. 8, so as to weld it to the connecting element. In this context, the connecting element is likewise made of a weldable material and in particular of the same weldable material as the associated semi-finished product to be welded thereto or of a different weldable material suitable for being connected to the associated semi-finished product by welding in each case. In the following, embodiments of connecting elements are described with reference to FIGS. 7 and 8.

In the embodiment shown in FIG. 1, the semi-finished product provision device 26 has by way of example at least one roller device 9 having a roller 10 on which a semi-finished product 7 is provided so as to be unwindable. The semi-finished product 7 may subsequently be cut to size to the length of the desired polyhedron edge of an associated polyhedron to be manufacture of the polyhedral net.

Additionally or alternatively, the semi-finished product provision device 26 may also have the semi-finished product at the predetermined length or lengths of the polyhedron edges of the polyhedron to be manufactured of the polyhedral net. If the net is manufactured from different-sized polyhedra or different polyhedra and thus different-length polyhedron edges, the semi-finished product having the corresponding lengths may already be provided in the semi-finished product provision device 26 in advance. In this way, for each desired length of the associated polyhedron edge, the semi-finished product can be provided by the semi-finished product provision device 26 and supplied by the supply device 6 and processed further. In this case, the semi-finished product thus no longer has to be adapted in length and cut to size, but rather can be welded directly to form the associated polyhedron of the polyhedral net. The semi-finished product provision device 26 may have at least one or more storage pallets or storage containers in which for example semi-finished product rods of at least one length, at least one material and/or at least one predetermined cross section are received and provided.

In the case of additional connecting elements, the production facility 1 may also have a connecting element provision device (not shown), for example one or more storage pallets or storage containers etc., in which the connecting elements are provided.

By way of example, the supply device 6 is or has a robot device 12. The robot device 12 in turn has at least one supply robot arm 13, which receives the semi-finished product 7 from the semi-finished product provision device 26 so as to supply the semi-finished product 7 for example to a processing station 14 having at least one construction platform 15 and position it in a desired position on the corresponding construction platform 15 for further processing. The supply device 6, here the supply robot arm 13 in FIG. 1, receives the semi-finished product and unwinds a part thereof from the roller 10 of the roller device 9. In the case of a storage pallet or storage container, the supply robot arm 13 receives the desired or predetermined semi-finished product off the storage pallet or out of the storage container.

If the semi-finished product 7 is welded to another semi-finished product 7 via a connecting element (not shown) provided in between, instead of directly, the supply robot arm 13 receives the provided connecting element from the connecting element provision device (not shown) and positions it to be welded to the associated semi-finished 7. In principle, the semi-finished product 7 and the connecting elements may be supplied and positioned by the one shared supply robot arm 13 or by means of two supply robot arms, one for supplying the associated semi-finished product and one for supplying the associated connecting element.

Further, the production facility 1 has as least one cutting and welding device for welding the semi-finished product 7 and where applicable the connecting element. In the embodiment shown in FIG. 1, by way of example the robot device 12 is equipped with a cutting and welding robot arm 16 as a cutting and welding device.

Alternatively, instead of the cutting and welding robot arm 16, a separate robot arm may also be provided as a welding robot arm, and optionally a separate robot arm may additionally be provided as a cutting robot arm if it is additionally necessary to cut to size or shorten the semi-finished product 7. In the embodiment shown in FIG. 1, the semi-finished product 7 is unwound from the roller 10 as a type of continuous strip and therefore has to be shortened or cut to size to form the polyhedron edges 5 at the length which is desired or determined in each case and where applicable in the desired shape of the semi-finished product end 27, as is shown in the following FIGS. 14 to 20. Since the associated polyhedron edge 5 is welded to other polyhedron edges 5 or where applicable to additional connecting elements to form the polyhedral net, the production facility 1 in FIG. 1 has for example a cutting and welding robot arm 16. However, as described above, for cutting the semi-finished product 7 to size a separate cutting robot arm may also be provided. In this context, the cutting robot arm may by way of example be formed so as to cut through the semi-finished product by welding or by means of a cutting blade device, a scissor device, a laser cutting device and/or a saw device or another suitable cutting tool or combination of cutting tools. The following FIG. 14-20 show various cut-off ends 27 of semi-finished products 7. Depending on the end 27 to be manufactured of the semi-finished product 7 and the subsequent connection thereof to another semi-finished product 7, in particular to a polyhedron node point 8 or other welding point (not shown), for cutting the semi-finished product 7 the cutting robot arm may have for example a scissor device or another suitable cutting device or combination of cutting devices, for example so as to cut off the end 27 of the semi-finished product 7 in a straight line, as is shown in the following FIG. 18, or to cut it off at an associated angle α or α1, α2, α3 etc. to manufacture a for example conical end 27, as in the following FIGS. 16 and 17, or a pyramid-shaped end 27, as is shown in the following FIGS. 14, 15, 19 and 20.

In one embodiment, the processing station 14 and in particular the construction platform 15 may optionally additionally have at least one optional mounting device (not shown) for receiving and holding the semi-finished product 7 supplied by the supply robot arm 13, so as to shorten the semi-finished product in length if required and to weld it. In this context, the mounting device may for example be a stationary mounting which is formed to receive and hold or fix the semi-finished product in such a way that it cannot slide undesirably. Likewise, the mounting device may also be a mobile mounting, for example in the form of at least one additional robot arm of the robot device 12 for holding the semi-finished product 7 supplied by the supply robot arm 13.

In this context, the construction platform 15 may likewise be formed stationary, in other words fixed in place, or alternatively movable, for example in at least one, two or all three spatial directions. In this context, the construction platform 15 may, as indicated in FIG. 1 by the coordinate system, in particular be formed movable up and down (Z direction), left and right (X direction) and/or backwards and forwards (Y direction). Preferably, the construction platform 15 is formed in such a way that it offers up to at least six degrees of freedom.

In one embodiment, the construction platform 15 may operate and be formed similarly, in particular being formed movable in all spatial directions. On the construction platform 15, at the start of a new component production, a metal plate 32 for example may be provided as a component carrier or the construction platform 15 itself may be formed as a metal plate of this type. Subsequently, one or more of the semi-finished products 7 are welded onto the metal plate 32 as part of the component to be manufactured or as a mounting and support (not shown) for the component to be manufactured. The metal plate 32 thus also simultaneously acts as a mounting device. These semi-finished products 7 welded to the metal plate 32 may subsequently be cut to size again together with the metal plate 32 or alternatively be cut to size directly by the metal plate 32 so as to obtain the finished component desired in each case. This may take place either by means of the cutting robot arm or manually, to mention just two examples. In this context, the metal plate 32 further has the advantage that in this way the component can be fixed to the metal plate 32 automatically during the manufacture of the desired component and can without difficulty be rotated in at least one or all spatial directions, in particular during the production process, together with the metal plate 32, for example by means of a component platform 15 movably connected to the metal plate 32, as in FIG. 1. Further, the metal plate 32 can be transported in a very simple manner, for example between different workstations, along with the semi-finished product(s) 7 welded thereto, without the construction of semi-finished products 7 welded together itself having to be clasped, since it is already welded rigidly to the metal plate 32 via one or more semi-finished products 7.

However, the invention is not limited to the mentioned examples of a mounting device and a construction platform. Any other stationary and/or movable mounting device may be provided which is suitable for receiving the supplied semi-finished product so as to weld the semi-finished product and where applicable shorten it in length. Subsequently, in further steps, the next supplied semi-finished products 7 are welded to the semi-finished product 7 received in the mounting device, in particular at the polyhedron node points 8, and where applicable shortened in length, so as to form the component 2 from polyhedra 4.

If additional connecting elements are provided for connecting the semi-finished products 7, in further steps a connecting element is initially positioned on the semi-finished product 7 and the semi-finished product 7 is subsequently rigidly connected thereto by welding. After this, the next semi-finished product 7 is supplied and rigidly connected to the connecting element by welding to manufacture the component 2 from a net of at least two polyhedra 4.

A cutting device can be dispensed with if the polyhedron edges of the polyhedral net of the component 2 are for example manufactured from semi-finished products 7 of the same length which are provided at this length by the semi-finished product provision device. Likewise, for example if there are at least two different required lengths of the polyhedron edges of the polyhedral net of the component, the semi-finished products may be provided in the semi-finished product provision device at these at least two required lengths in advance. In both cases, a cutting device for shortening and cutting to size the semi-finished products 7 to the required length of the associated polyhedron edges 5 is not required.

Instead, the semi-finished products 7 may be provided with the predetermined length by the semi-finished product provision device 26, and each semi-finished product may be received at the required length from the supply robot arm 13 and supplied to the processing station 14 and construction platform 15 and positioned. Subsequently, the semi-finished product 7 is welded by means of the welding robot arm, in particular at the associated polyhedron node point 8, so as to construct or manufacture the component 2 from the net of at least two or a plurality of polyhedra 4, as for example in the following FIGS. 9 to 13.

As described above, the semi-finished product 7 forms a polyhedron edge 5 of a polyhedron 4. In this context, as is shown using the example of the carrier 3 in FIG. 1, in principle it is also possible for the polyhedron edges 5 of a plurality of polyhedra 4 to be provided by a single semi-finished product 7 as a shared polyhedron edge 5, for example if the edges 5 form a straight line. In this context, the semi-finished product which forms a plurality of polyhedron edges is welded, by the other polyhedron edges thereof, to welding points at which the other polyhedron edges meet the semi-finished product. Thus, the semi-finished product 7 may be welded not only at a polyhedron node point 8 but also at further welding points.

As a result of the supply robot arm 13, the semi-finished product 7 may, in a very simple manner, be arranged in a desired position, for example at a welding point, in particular at a polyhedron node, and welded to a semi-finished product 7 located there and where applicable be shortened in length beforehand and/or afterwards. In this context, the semi-finished product 7 may be shortened on the construction platform 15 or at another point in the processing station 14 so as subsequently to be welded to another semi-finished product 7 or associated connecting element on the construction platform 15 to form the component 2 from polyhedra 4.

By means of the cutting robot arm or welding and cutting robot arm 16, the supplied semi-finished product 7 may, in particular if it is unrolled and supplied from the roller 10 in FIG. 1 as a continuous strip, be shortened to the desired length without difficulty. This has the advantage that the semi-finished product 7 can be supplied as a continuous strip, and can be adapted in length, in accordance with the component 2 to be manufactured, without difficulty. This is advantageous in particular in the case of very complex components 2 which are constructed from a plurality of differently dimensioned polyhedra 4, such as the cab frame in the following FIGS. 9 to 13, or in the case of a changing program of the components to be manufactured.

The semi-finished product 7 may thus be tailored to the exact edge length 5 of the associated polyhedron 4 or else to the edge length of a plurality of polyhedra 4 if the polyhedron edges 5 of a plurality of polyhedra 4 are to be formed by a single, continuous semi-finished product 7. The semi-finished product 7 shortened in this manner can subsequently be positioned at the associated welding position, in particular a polyhedron node point, and so forth.

The occurring method steps described with reference to the embodiment of the production facility 1, such as supplying the semi-finished product 7, positioning, cutting and welding the semi-finished product 7, optionally additionally supplying and welding connecting elements to form the finished component 2 from a net of polyhedra 4, may be carried out in an automated and preferably fully automated manner.

For automated and in particular fully automated manufacture of the component in question, some or all of the devices of the production facility 1, in particular at least the supply device 6, the robot device 12 and the robot arm(s) thereof, including for example the supply robot arm 13 and the cutting and welding robot arm 16, and/or the mobile construction platform 15, in particular movable metal plate, are controllable by a control device 11.

In this context, the control by the control device 11 takes place as a function for example of the polyhedral net, into which the desired component is expanded and which is to be welded together from the semi-finished products 7, and of the semi-finished product(s) 7 and connecting element(s) 21 present. For this purpose, the control device 11 controls for example devices of the production facility in such a way that the associated semi-finished product to be welded which is required for the associated desired portion of the polyhedral net of the component to be manufactured is supplied, positioned, shortened to a desired length where required, and welded to another semi-finished product 7 for example at an associated polyhedron node point 8, and where applicable a required desired connecting element 21 is supplied, positioned and welded. Information required for the control and in particular for fully automated control of the devices 6, 12, 13, 14, 15, 16, 26 and in particular of all of the devices of the production system 1 by the control device 11 may be saved in advance, for example in a storage device, so as to be retrievable by the control device 11. This information is for example the position, length, cross-sectional shape of the semi-finished product 7, for example circular solid profile etc., the position of the semi-finished product 7, for example at an associated polyhedron node point 8 or other welding point of the component to be manufactured, the semi-finished product material, where required the shape of the connecting element 21, the position of the connecting element 21, the position of the construction platform 15 during welding and/or transportation of the semi-finished product 7 and where applicable of the connecting element 21, etc., and may be provided saved stored in advance in at least one storage device so as to be retrievable by the control device 11. However, the invention is not limited to this specific configuration and control of the production facility 1 by the control device 11. Any other form of control by a control device and production facility may be provided for manufacturing a component according to the invention, in particular manufacturing the component according to the invention in a partially or fully automated manner.

The invention thus provides in particular a more efficient alternative for tool-free additive production of lightweight constructions. This is made possible by the use of standardised, cost-effective semi-finished products 7, which can be put to use without further processing. As a result, it is also made possible to avoid high-investment laser systems and to replace them with a conventional, robust welding method and a corresponding welding facility. In addition, it is ensured that the components 2 to be processed are scalable, and the flexibility during manufacture is thus increased.

The additive production logic described above with reference to FIG. 1 leads to a major reduction in the processing time as a result of the use of semi-finished products 7 instead of producing a component directly from a powdered substance. An additional cost advantage can also be achieved by way of the relatively favourable system costs and raw material costs.

The following FIGS. 2 to 6 show various examples of cross sections 17 or cross-sectional shapes of semi-finished products 7 for manufacturing the component according to the invention.

Aside from a circular or hollow cylindrical cross section, the semi-finished product 7 may also have for example a hollow cylindrical cross section 17 having an additional transverse wall 18, as shown in FIG. 2, a hollow semicylindrical cross section 17 having an optional transverse wall 18 indicated by a dotted line, as shown in FIG. 3, or a cross section 17 for example in the shape of a three-quarter circle, as shown in FIG. 4. Further, the semi-finished product 7 may also have for example a cross-shaped or star-shaped cross section 17, as in FIG. 5, or a cross-shaped or star-shaped hollow profile having a cross-shaped or star-shaped external contour 19 and, as indicated by a dashed line in FIG. 5, having a for example cross-shaped or star-shaped internal contour 20. Likewise, the semi-finished product 7 may have a polygonal cross section 17, for example a hexagonal cross section, as in FIG. 6, or a polygonal hollow profile having a polygonal external contour 19 and a different internal contour, for example a circular internal contour 20, as indicated by a dashed line in FIG. 6. However, the invention is not limited to the cross sections 17, alternatively also referred to as cross-sectional profiles, mentioned and shown in the drawings, and the combination of the external contour 19 and internal contour 20 of the cross sections 17. The semi-finished product 7 may have, as a solid profile or hollow profile, any cross section 17 suitable for manufacturing the component 2 according to the invention from at least two polyhedra 4. In this context, the hollow profile cross section may have a round and/or angular internal contour 20, which is also the same as or different from the external contour 19; this applies to all embodiments of the invention.

FIGS. 7 and 8 further show different examples of connecting elements 21 in a highly simplified, purely perspective view, which is not to scale. For example, the connecting element 21 may be formed as a solid profile, as indicated in FIGS. 7 and 8 by a solid line, or as a hollow profile, as indicated in FIG. 7 by an additional dotted line. In this context, the connecting element 21, as a hollow profile, may have at least one opening 22 for introducing an associated semi-finished product 7 or else for example two opposite openings (not shown) for passing the semi-finished product 7 through. The semi-finished product 7 is subsequently fixed to the connecting element 21 by welding. In the embodiment shown in FIG. 7, the connecting element 21 is a polygon, for example a quadrilateral cube. In this context, on one face of the cube, a semi-finished product 7 in the form of a solid profile having for example a triangular cross section is welded. On another face of the cube, an end of a semi-finished product 7 is received in a corresponding depression 23 of the cube in the form of a solid profile and welded thereto. In this context, the semi-finished product 7 is formed as a solid profile having a for example circular cross section, the end of which is received in the depression 23 of the cube having a corresponding circular cross section.

Further, FIG. 8 shows a connecting element 21 in the form, by way of example, of a cylinder having a solid profile, the cylinder optionally additionally having a depression or, as shown in FIG. 8, a continuous opening 22 for inserting or fully passing through an associated semi-finished product 7. The connecting element 21 also has, by way of example, a projection 24, for example a cylindrical projection, as indicated by a dotted line in FIG. 8, for plugging on a corresponding cylindrical semi-finished product 7 in the form of a hollow profile having a circular external contour 19 and a circular internal contour 20. The semi-finished product 7 in question is subsequently welded to the connecting element 21.

The connecting element 21 in the form of a hollow profile, here for example the polygonal, hollow cube, has the advantage that the connecting element is particularly light. By contrast, the connecting element 21 in the form of a solid profile, here for example in the form of a polygonal, solid cube or cylinder, has the advantage that it is particularly stable.

Furthermore, identical semi-finished products 7, in particular semi-finished products having an identical cross section, identical dimensioning and/or identical weldable material etc., or different semi-finished products, in particular semi-finished products having a different cross section, as in FIGS. 7 and 8, different dimensioning and/or a different weldable material etc., may be fixed to the connecting element 21 by welding. The examples shown in FIGS. 7 and 8 of connecting elements 21 and semi-finished products 7 fixed thereto are merely examples, and the invention is not limited thereto. Any type and form of connecting element 21 and associated semi-finished product 7 or semi-finished products 7 suitable for interconnection by welding may be provided.

The following FIGS. 9A, 9B and 11 to 13 show a further embodiment of a component 2 according to the invention, which can be manufactured for example by means of the production facility described above with reference to FIG. 1.

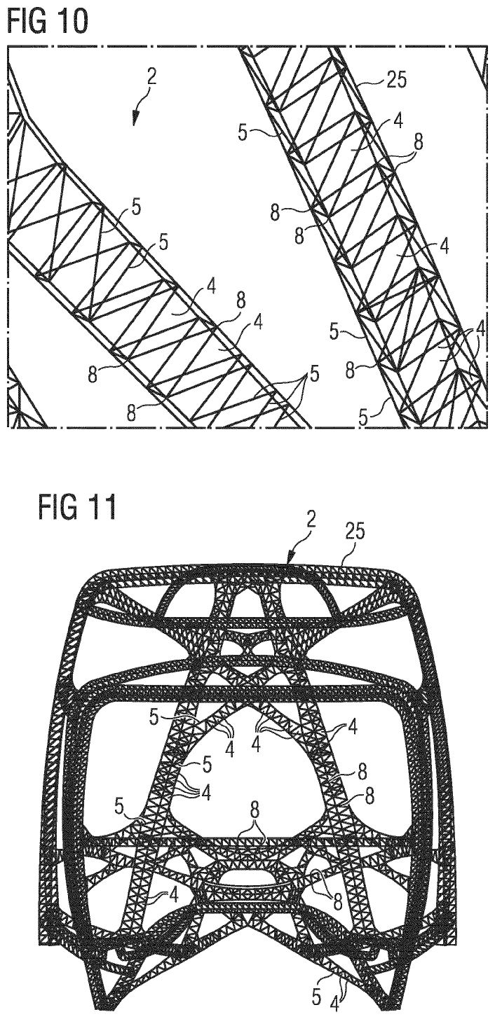

The component 2 shown in FIG. 9A, 9B to 13 is a lorry cab, more precisely a lorry cab frame 25, consisting of a net of polyhedra 4, more precisely a net for example of triangular pyramids. FIG. 9A shows a network 31 of the polyhedra which were derived in a first step from the solid body (not shown here) of the lorry cab or cab frame to be manufactured. FIG. 9B is a perspective view of the cab frame 25 consisting of a net of polyhedra, and FIG. 10 is an enlarged detail of the cab frame 25 of FIG. 9B. In this context, the entire polyhedral structure of the net 31 of polyhedra has been reduced, from the example as shown previously in FIG. 9A, in the further second step. In this context, the entire polyhedral structure and thus the net 31 of polyhedra, as shown previously in FIG. 9A, has additionally been optimised or further optimised, for example in accordance with one or more specified loading scenarios. In this context, it has been possible to dispense with many of the polyhedra from FIG. 9A, as is shown by the result in FIG. 9B. The nets of polyhedra shown in FIGS. 9A and 9B serve as examples to show how a structure based on polyhedra, or in other words based on semi-finished products or rods, can be manufactured more simply and rapidly from a predetermined volume element, for example a lorry cab, than for example by a generative layer construction method such as laser sintering.

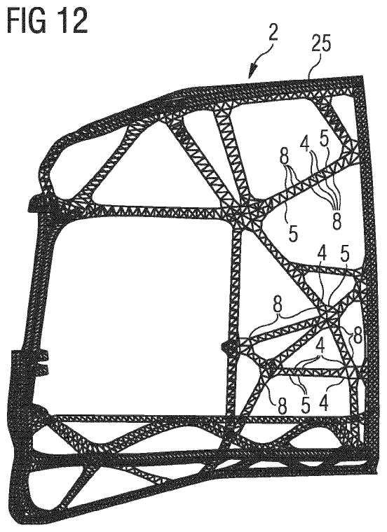

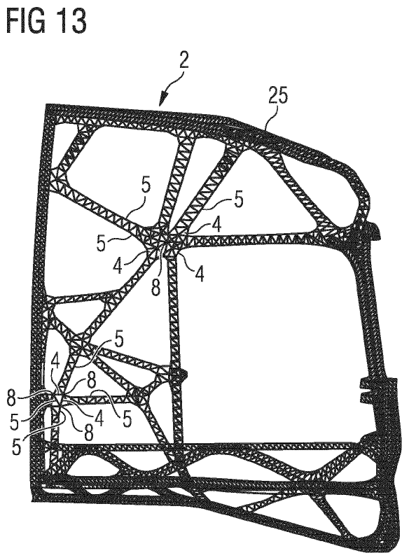

Further, FIG. 11 is a front view of the cab frame 25, and FIGS. 12 and 13 are each a side view of the cab frame 25. As can be derived from FIG. 9B to 13, the cab frame 25 is constructed from a net of a plurality of polyhedra 4, which are interconnected, more precisely welded together, at polyhedron node points 8. The arrangement, dimensioning, semi-finished product material, semi-finished product cross section, connecting element material, connecting element shape, connecting element cross section, for example solid profile or hollow profile optionally additionally having one or more depressions, openings and/or projections etc., and/or the polyhedron shape, for example tetrahedron, pentahedron, heptahedron etc., of the component 2 formed from the polyhedra 4, here a cab frame 25, may be combined as desired. The component 2 may thus be formed from the same polyhedra 4, in other words tetrahedra or triangular pyramids, as in the example shown in FIG. 9B-13. The component according to the invention need not necessarily be manufactured from triangular pyramids, and in particular need not necessarily be manufactured exclusively from triangular pyramids. The component according to the invention may be manufactured from any other type of polyhedra and in particular any combination of at least two different polyhedra. Various examples of polyhedra are mentioned above, and may be combined with one another as desired so as to manufacture the component according to the invention which is desired in each case.

The polyhedra 4 having polyhedron edges 5, for example the polyhedra 4 in FIG. 9B and FIGS. 10 to 13, may have the same dimensioning, like for example the polyhedra in the carrier in FIG. 1, or have different dimensioning in at least some cases, like the polyhedra 4 in the cab frame 25. As is shown by way of example in FIG. 11, some of the polyhedra 4 and thus the polyhedron edges 5 thereof may be formed larger than, the same size as or smaller than other polyhedra 4 and the polyhedron edges 5 thereof. As a semi-finished product 7 for manufacturing the polyhedra 4, a single semi-finished product or type of semi-finished product or various semi-finished products or types of semi-finished product may be used. In the case of different semi-finished products or types of semi-finished product, the semi-finished products or types of semi-finished product differ in at least one feature, for example dimensioning, material or cross section/cross-sectional shape. As regards a different cross section/cross-sectional shape, the component may for example be formed from semi-finished products having a circular solid profile or hollow profile cross section and semi-finished products having a quadrilateral solid profile or hollow profile cross section etc., to name one example.

In this context, the semi-finished product of the polyhedra may have the same cross section/cross-sectional shape, for example a circular solid profile or circular hollow profile cross section, and also the same dimensioning or different dimensioning, for example different-sized cross sections, for example different-sized circular solid profile cross sections or different-sized circular hollow profile cross sections.

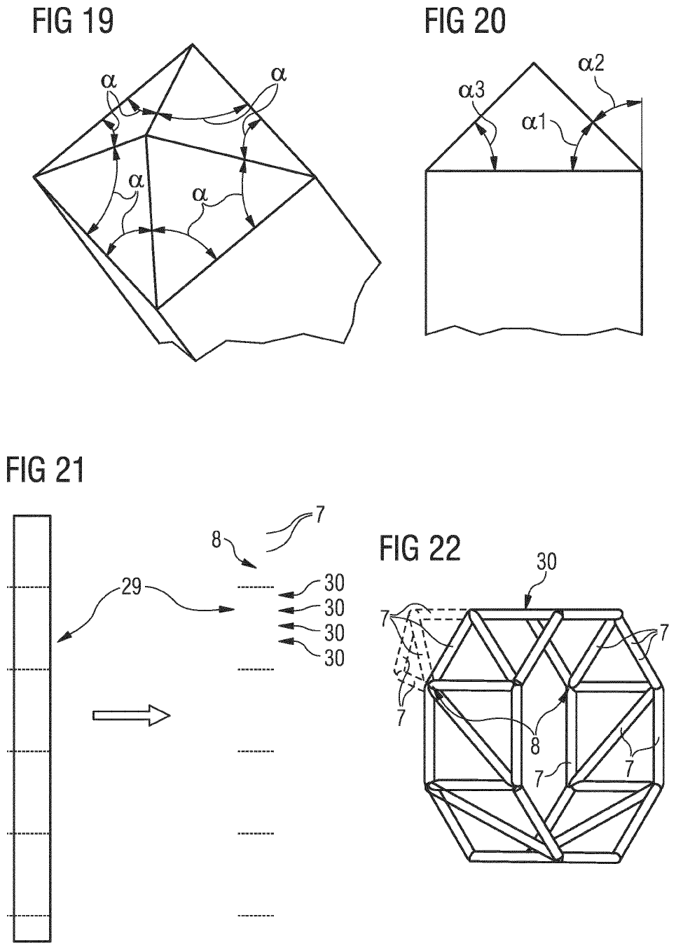

FIGS. 14 to 20 further show different shapes of cut-off ends 27 of semi-finished products 7. In the embodiment in FIGS. 14, 15, 19 and 20, the semi-finished product is shortened or cut to size in such a way that the end 27 thereof is pyramid-shaped or forms a pyramid-shaped tip. In this context, the semi-finished product 7 has by way of example a polygonal cross section, for example a quadrilateral and in particular square cross section. The semi-finished product 7 is welded, by the pyramid-shaped end 27 thereof having for example a square base surface, to a polyhedron node point 8 having at least one, two or three other semi-finished product ends 27. In this context, the other semi-finished products 7 and the semi-finished product ends 27 thereof preferably have a semi-finished product end matching the pyramid-shaped end 27, for example the same pyramid-shaped end 27, as is shown in FIGS. 14 and 15. FIG. 15 shows the two semi-finished products 7 welded together at the semi-finished product ends 27 thereof, and in FIG. 14 welding faces are marked with a dashed circle. As is shown in FIGS. 19 and 20, the associated angle of inclination a of the pyramid-shaped end 27 of the semi-finished product 7 may vary when the semi-finished product 7 is cut, for example in the case of larger cross sections of the semi-finished product 7. The angle of inclination α or α1, α2, α3 of the pyramid-shaped end 27 of the semi-finished product 7 is thus determined from the angles of inclination α1 and α2 of the pyramid-shaped semi-finished product ends 27 which are to be welded together in each case, as is indicated in FIG. 20.

As is shown in FIGS. 16 and 17, the semi-finished product end 27 may also be formed conical. In this context, the semi-finished product 7 has for example a circular cross section, and the conical semi-finished product end 27 accordingly has a circular cross section. In this context, the semi-finished product ends 27 to be welded together are shown, in a highly simplified manner and not to scale, by way of a dashed circle in FIG. 16. The ends are welded together at a polyhedron node point 8, as is indicated in FIG. 17, and interconnected by welding material. As previously in FIG. 15, the illustration in FIG. 17 is highly simplified and not to scale. In particular, as previously in FIG. 15, the welding material is not shown in FIG. 17 for reasons of clarity.

FIG. 18 shows a further embodiment of semi-finished product ends 27 which are welded together at a polyhedron node point 8. In this context, the semi-finished product ends 27 are planar or completely flat, since the semi-finished product 7 has been cut to size or cut through in a straight line at the end thereof. The semi-finished products 7 have for example a circular cross section in FIG. 18. They are positioned with respect to one another as shown in FIG. 18 for welding. A gap is thus formed between the flat semi-finished product ends 27, and is filled by the welding material 28 so as to weld the semi-finished product ends 27 together.

Analogously to the end 27 to be manufactured of the semi-finished product 7 and its subsequent connection to another semi-finished product 7, in particular at a polyhedron node point 8 or another welding point, for cutting the semi-finished product 7 the cutting robot arm may have for example a scissor device or another suitable cutting device or combination of cutting devices, so as by way of example to cut the end of the semi-finished product 7 in a straight line, as in FIG. 18, or at an associated angle to manufacture a for example conical end, as in FIGS. 16 and 17, or a pyramid-shaped end, as is shown in FIGS. 14, 15, 19 and 20.

As noted above, FIGS. 21 and 22 show a further example of the formation of a component from a net of polyhedra. FIG. 21 shows a tube 29 and how it is decomposed into a net of polyhedra. The tube may be constructed from annular portions or ring segments 30 of semi-finished products 7, which are welded to one another for example at polyhedron node points 8, like the ring segment 30 shown in a perspective view in FIG. 22. In this context, the ring segment 30 is formed for example from semi-finished products 7, which are welded at the polyhedron node points 8 thereof to form triangles and which are in turn welded together to form a shared quadrilateral, the quadrilaterals in turn being welded together to form a ring. Adjacent to the ring segment 30, further ring segments 30 of this type may be provided to form the pipe 29, as is indicated with a dashed line for a portion of the next ring segment 30. In this way, the pipe can be constructed in the form of a net of polyhedra or a rod structure consisting of semi-finished products 7, and manufactured as described above.

Although the present invention has been described herein with reference to the preferred embodiments, it is not limited thereto, but rather can be modified in various ways. In particular, the configurations and embodiments described above, in particular individual features thereof, may be combined with one another.

### LIST OF REFERENCE NUMERALS

1 Production facility
2 Component
3 Carrier
4 Polyhedron
5 Polyhedron edge
6 Supply device
7 Semi-finished product
8 Polyhedron node point
9 Roller device
10 Roller
11 Control device
12 Robot device
13 Supply robot arm
14 Processing station
15 Construction platform
16 Cutting and welding robot arm
17 Cross section
18 Transverse wall
19 External contour
20 Internal contour
21 Connecting element
22 Opening
23 Depression
24 Projection
25 Cab frame
26 Semi-finished product provision device
27 Semi-finished product end
28 Welding material
29 Tube
30 Ring segment
31 Net of polyhedra
32 Metal plate

1. Method for manufacturing, in an automated manner, a component (2) from polyhedra (4) having polyhedron edges (5), which are formed from a semi-finished product (7), the method having the steps of:
subdividing the component (2) to be produced into a net of polyhedra (4), consisting of polyhedron edges (5), which are interconnected at the polyhedron node points (8) thereof to form the net,
providing a semi-finished product provision device (26), which provides the semi-finished product (7), wherein the semi-finished product (7) is a bar-shaped weldable metal or a bar-shaped weldable metal alloy,
providing a supply guide device (6) for supplying the semi-finished product (7) from the semi-finished product provision device (26) and positioning the semi-finished product (7),
providing a cutting and welding device (16) or a welding device for welding and a cutting device for cutting to size the semi-finished product (7),
supplying the semi-finished product (7) by way of the supply device (6),
constructing the net of polyhedra (4) by positioning the supplied semi-finished product (7) in the position of the polyhedron edge (5) to be formed at the associated polyhedron node point (8) of the net of polyhedra (4) in each case, and fixing the semi-finished product (7) at the polyhedron node point (8) by welding.

2. Method according to claim 1, wherein the semi-finished product provision device (26) provides the semi-finished product (7) with the predetermined length or lengths of the polyhedron edges (5) of the polyhedra (4) of the net and the supply guide device (6) supplies the semi-finished product (7) to the semi-finished product provision device (26), as a function of or in accordance with the length of the polyhedron edge (5) to be formed in each case, and positions said semi-finished product.

3. Method according to claim 1, wherein the semi-finished product (7) is cut to size to the predetermined length of the polyhedron edge (5) to be formed, the semi-finished product (7) being cut to size before and/or after the semi-finished product (7) is positioned in the position of the polyhedron edge (5) to be formed at the associated polyhedron node point (8) of the net of polyhedra (4) in each case; and/or wherein the semi-finished product (7) is cut to size before and/or after the semi-finished product (7) is fixed to the polyhedron node point (8) by welding.

4. Method according to claim 1, wherein the polyhedra (4) are manufactured from an identical semi-finished product (7), or at least some of the polyhedra (4) of the component (2) are manufactured from at least two different semi-finished products (7), the two different semi-finished products (7) differing from one another in particular at least in material, dimensioning and/or cross section (17).

5. Method according to claim 1, characterised by:
providing a connecting element provision device for providing a connecting element (21),
supplying the connecting element (21) by means of the supply device (6),
positioning the supplied connecting element (21) as a polyhedron node point (8) in each case for fixing the polyhedron edges (5) associated with the polyhedron node point (8) to the connecting element (21) by welding to form the net of polyhedra (4).

6. Method according to claim 5, wherein the polyhedron edges (5) of the polyhedra (4) of the net of polyhedra (4) are directly interconnected and welded together at at least some or all polyhedron node points (8), or interconnected via a connecting element (21) as a polyhedron node point (8) in each case and welded to the connecting element (21).

7. Method according to claim 1, wherein the same connecting element (21) is provided for at least some or all polyhedron node points (8) of the net of polyhedra (4), or at least two different connecting elements (21) are provided, the at least two different connecting elements (21) differing from one another at least in material, dimensioning and/or cross section (17), and/or wherein the connecting element (21) is of a weldable metal or a weldable metal alloy of the same material as the semi-finished product (7).

8. Method according to claim 1, wherein the the same material as the semi-finished product (7).

9. Component (2) which consists of a net of polyhedra (4) having polyhedron edges (5), the polyhedron edges (5) being formed from a semi-finished product (7), wherein the semi-finished product (7) is a bar-shaped weldable metal or a bar-shaped weldable metal alloy, and the component (2) being manufactured in particular by the method according to claim 1.

10. Component (2) according to claim 9, wherein the polyhedron edges (5) of the polyhedra (4)of the component (2) are directly interconnected and welded together at at least some or all polyhedron node points (8), or interconnected via a connecting element (21) as a polyhedron node point (8) in each case and welded to the connecting element (8).

11. Production facility (1) for manufacturing a component (2) from a net of polyhedra (4) having polyhedron edges (5), which are formed from a semi-finished product (7), wherein the semi-finished product (7) is a bar-shaped weldable metal or a bar-shaped weldable metal alloy, by a method according to claim 1, the production facility (1) having:
a semi-finished product provision device (26) for providing the semi-finished product (7),
a supply guide device (6) for supplying the semi-finished product (7) from the semi-finished product provision device (26) and positioning the semi-finished product (7),
a cutting and welding device, or a welding device for welding the semi-finished product (7) and a cutting device for cutting to size the semi-finished product (7).

12. Production facility according to claim 11, wherein the semi-finished product provision device (26) has at least one roller device (9) having at least one roller (10), at least one storage plate and/or at least one storage container, and/or wherein the production facility (1) has a connecting element provision device, the connecting element provision device having in particular at least one storage plate and/or at least one storage container.

13. (canceled)

14. Production facility according to claim 11, wherein the production facility (1) has at least one robot device (12), the robot device (12) having at least one cutting and welding robot arm (16), at least one welding robot arm, at least one cutting robot arm and/or at least one supply robot arm (6) for supplying the semi-finished product (7) and/or supplying a connecting element (21).

15. Production facility according to claim 11, wherein the production facility has at least one construction platform (15), the at least one construction platform (15) being a stationary or mobile construction platform (15), the mobile construction platform (15) being formed movable in at least one degree of freedom, the at least one construction platform (15) preferably having at least one mounting device for receiving and holding a supplied semi-finished product (7), the mounting device in particular being a metal plate (32).

16. Method according to claim 8, wherein the method is a method for the fully automated manufacturing of a component (2) from polyhedra (4) having polyhedral edges (5), which are formed from a semi-finished product (7).
